(19) United States
(12) Patent Application Publication
(10) Pub. No.: US 2016/0140581 A1
(43) Pub. Date: May 19, 2016

(54) Market Share Simulator

(71) Applicant: The Sun Products Corporation, Wilton, CT (US)

(72) Inventors: Margaret HEILE, Park City, UT (US); Jeffery Clark STRONG, Midway, UT (US); Sandra C. SHIFRIN, Wilton, CT (US)

(73) Assignee: The Sun Products Corporation, Wilton, CT (US)

(21) Appl. No.: 14/940,846

(22) Filed: Nov. 13, 2015

Related U.S. Application Data
(60) Provisional application No. 62/079,386, filed on Nov. 13, 2014.

(51) Int. Cl. G06Q 30/02; G06Q 10/06

(52) U.S. Cl. CPC G06Q 30/0201; G06Q 10/067

(57) ABSTRACT

A system, method, and computer program product for determining an expected market share for a generic product, are provided. A market share simulator receives a selected category for a selected attribute of a generic product. Based on the selected category and the selected attribute for the product, the market share simulator determines the utility of the selected attribute, and a sum of a plurality of utilities for the selected attribute associated with a plurality of products, wherein the generic product and the plurality of products compete for a portion of a market share. Market share simulator then compares the utility of the selected attribute to the sum of the plurality of utilities to generate an expected market share for the generic product.

This application claims priority to provisional U.S. Patent Application No. 62/079,386, filed on Nov. 13, 2014, which is herein incorporated by reference in its entirety.

### FIELD

Embodiments relate generally to data modeling, and specifically to data modeling that predicts market share of a product.

### BACKGROUND

Before placing a product on the market, a retailer attempts to determine a market share that the product will accumulate. Market share of a product can be important because it is an indication of revenue that the product will generate, as well as the financial impact of the product on the retailer's top and bottom line. Typically, one way to determine the market share of a product is to evaluate performance of similar products that have already been placed on the market. However, as consumer preferences change, evaluating performance of a product based on similar products may lead to distorted results.

### BRIEF SUMMARY

Embodiments include a system, method, and computer readable medium for determining an expected market share for a product. A system includes one or more memories and one or more processors that store and execute a market simulator. The market share simulator receives a selected category for a selected attribute of a generic product. Based on the selected category and the selected attribute for the product, the market share simulator determines the utility of the selected attribute, and a sum of a plurality of utilities for the selected attribute associated with a plurality of generic products, wherein the generic product and the plurality of brand products compete for a portion of a market share. Market share simulator then compares the utility of the selected attribute to the sum of the plurality of utilities to generate an expected market share for the generic product.

Embodiments also include a system where the market share simulator is further configured to display a first attribute and a second attribute for the generic product, wherein the first attribute is associated with a first plurality of categories and the second attribute is associated with a second plurality of categories, exclusive from the first plurality of categories associated with the first attribute, and wherein the selected attribute is the first attribute and the selected category is included in the first plurality of categories or the second attribute and the selected category is included in the second plurality of categories.

Embodiments also include a system where the market share simulator is further configured to display a first attribute associated with a first plurality of categories in a first tier and a second plurality of categories in a second tier, wherein the first tier and the second tier correspond to a price of the generic product.

Embodiments also include a system where the market share simulator uses a discrete choice model that determines the utility of the selected attribute and the sum of the plurality of utilities.

Embodiments also include a system where the market share simulator is further configured to receive a second selected category for the selected attribute of the generic product and determine whether the second selected category results in an increase or a decrease in the expected market share of the generic product compared to the selected category.

Embodiments also include a system where to determine the sum of the utilities, the market share simulator is further configured to utilize data generated using consumer simulations for the plurality of products.

Embodiments also include a system where the consumer simulations for the plurality of products generate the plurality of utilities for an attribute based on a discrete choice model.

Embodiments also include a system where the market share simulator is further configured to display the expected market share for the generic product.

Embodiments also include a system where the market share simulator is further configured to display the expected market share for the first tier and the second tier for the generic product.

Embodiments also include a system where the plurality of products are brand products.

Embodiments include a method comprises receiving a selected category for a selected attribute of a generic product. Once received, based on the selected category a utility of the selected attribute is determined. A sum of a plurality of utilities for a plurality of attributes associated with a plurality of brand products, where the generic product and the plurality of brand products compete for a portion of a market share is also determined. A comparison of the utility of the selected attribute to the sum of the plurality of utilities is made, where the comparison generates an expected market share for the generic product.

Embodiments also include a method where displaying a first attribute and a second attribute for the generic product, wherein the first attribute is associated with a first plurality of categories and the second attribute is associated with a second plurality of categories, exclusive from the first plurality of categories associated with the first attribute, and wherein the selected attribute is the first attribute and the selected category is included in the first plurality of categories or the second attribute and the selected category is included in the second plurality of categories.

Embodiments also include a method where displaying a first attribute associated with a first plurality of categories in a first tier and a second plurality of categories in a second tier, wherein the first tier and the second tier correspond to a price of the generic product.

Embodiments also include a method where using a discrete choice model to determine the utility of the selected attribute and the sum of the plurality of utilities.

Embodiments also include a method where further comprising receiving a second selected category for the selected attribute of the generic product, and determining whether the second selected category results in an increase or a decrease in the expected market share of the product compared to the selected category.

Embodiments also include a method where determining the sum of the utilities, further comprises utilizing data generated using consumer simulations for the plurality of products.

Embodiments also include a method where the consumer simulations for the plurality of products generate the plurality of utilities for an attribute based on a discrete choice model.

Embodiments also include a method further comprising displaying the expected market share for the generic product.

Embodiments also include a method further comprising displaying the expected market share for the first tier and the second tier for the product.

Embodiments include a computer-readable storage medium having instructions stored thereon that, when executed by one or more processors, cause the one or more processors to perform operations comprising receiving a selected category for a selected attribute of a generic product. Once received, based on the selected category a utility of the selected attribute is determined. A sum of a plurality of utilities for a plurality of attributes associated with a plurality of brand products, where the generic product and the plurality of brand products compete for a portion of a market share is also determined. A comparison of the utility of the selected attribute to the sum of the plurality of utilities is made, where the comparison generates an expected market share for the generic product.

Embodiments also include a computer-readable storage medium where the instructions cause the one or more processors to perform operations, the operations comprising displaying a first attribute and a second attribute for the generic product, wherein the first attribute is associated with a first plurality of categories and the second attribute is associated with a second plurality of categories, exclusive from the first plurality of categories associated with the first attribute, and wherein the selected attribute is the first attribute and the selected category is included in the first plurality of categories or the second attribute and the selected category is included in the second plurality of categories.

Further embodiments, features, and advantages of the invention, as well as the structure and operation of the various embodiments, are described in detail below with reference to accompanying drawings.

### BRIEF DESCRIPTION OF THE DRAWINGS/FIGURES

The accompanying drawings, which are incorporated herein and form a part of the specification, illustrate embodiments, together with the description, further serve to explain the principles of the embodiments and to enable a person skilled in the relevant art to make and use the embodiments.

FIG. 1 is a block diagram of a consumer simulator, according to an embodiment.

FIG. 2 is a block diagram of a consumer simulator identifying successful drivers for an exemplary product, according to an embodiment.

FIG. 3 is a block diagram of a market share simulator, according to an embodiment.

FIGS. 4A and 4B are diagrams of a front-end display of a market share simulator for an exemplary product, according to an embodiment.

FIG. 5 is a flowchart of a method for determining expected market share for a product, according to an embodiment.

FIG. 6 is a block diagram of a computing environment where a consumer simulator and a market share simulate can execute, according to an embodiment.

FIG. 7 is a computer system where embodiments may be implemented.

Various embodiments will now be described with reference to the accompanying drawings. In the drawings, like reference numbers generally indicate identical or functionally similar elements. Additionally, the left-most digit(s) of a reference number generally identifies the drawing in which the reference number first appears.

### DETAILED DESCRIPTION

The following detailed description refers to the accompanying drawings that illustrate exemplary embodiments. Other embodiments are possible, and modifications can be made to the embodiments within the spirit and scope of the invention. Therefore, the detailed description is not meant to limit the embodiments.

When a retailer wishes to grow market share for a generic product, a retailer faces a number of business decisions. These decisions include: Which shoppers should the retailer target? Which formula should the retailer use to market the product? How does the retailer drive awareness for the product? How does a product stand out on a shelf? What is the best support plan for the business? How can the product's credentials be reinforced? What is the financial impact on the top and the bottom line? One way to simulate growth of a market share for a product is through a market share simulator. A market share simulator stores data collected by performing thousands of consumer preference simulations on an assortment of retailer and competing brand products. These simulations identify key success drivers included in the competing products. A market share simulator then allows a retailer to enter some or all of these success drivers and simulate which combination of the success drivers will increase the market share of a product. The market share simulator also allows a retailer to interpolate different combinations of the success drivers and optimize the increase in the market share of the product.

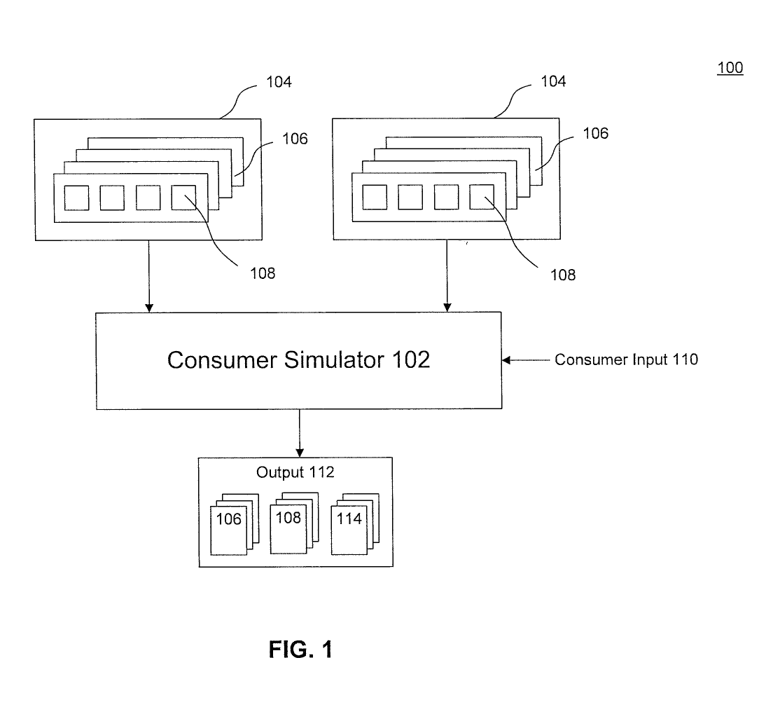

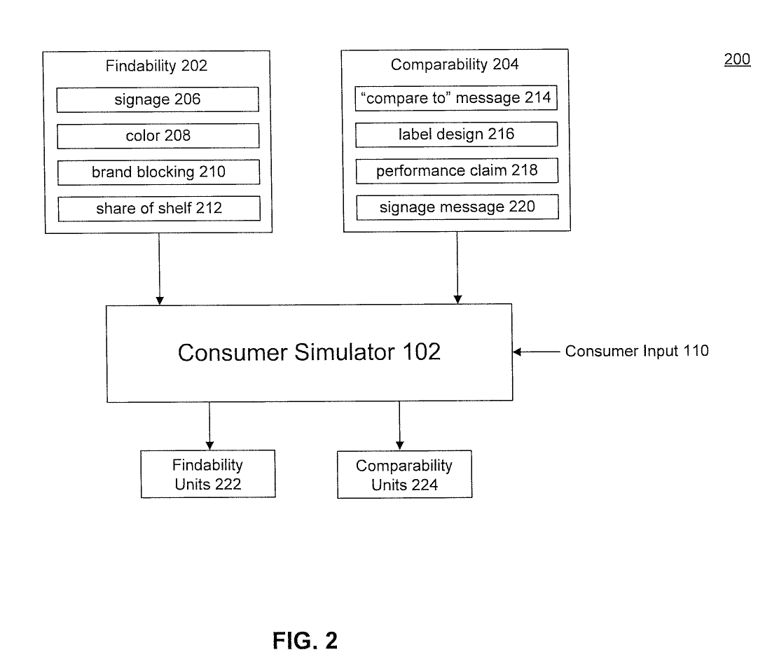

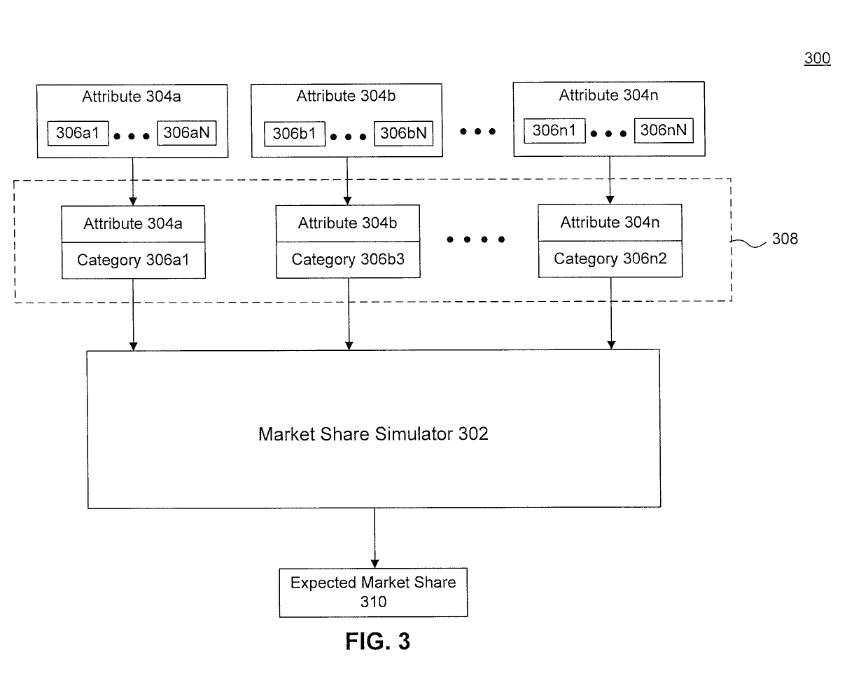

For example, embodiments may include a consumer simulator (discussed as consumer simulator 102 in FIGS. 1-2) for collecting and analyzing data submitted by thousands of consumers and a market share simulator (discussed as market share simulator 302 in FIGS. 3-5) for determining and displaying an expected market share to a retailer. In one embodiment, the market share simulator may use data generated by the consumer simulator from thousands of consumer simulations.

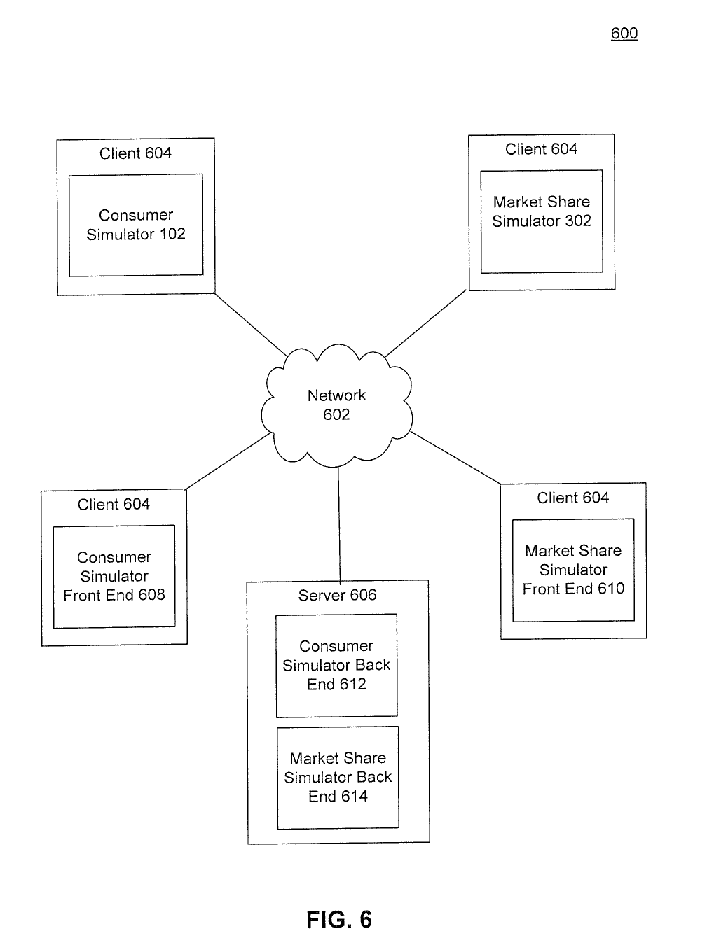

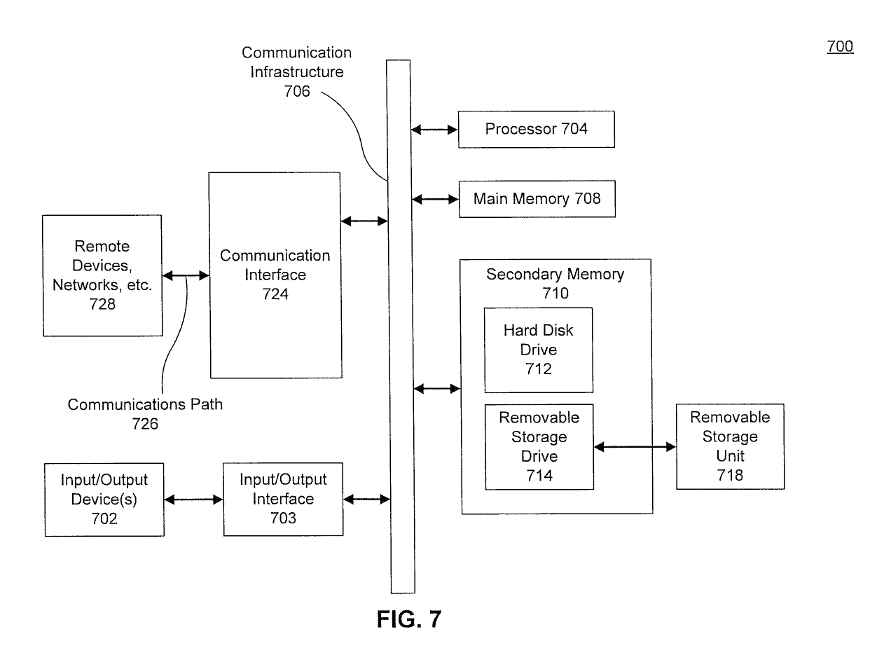

FIG. 1 is a block diagram 100 of a consumer simulator, according to an embodiment. A consumer simulator 102 in block diagram 100 determines a best product that consumers seek out of numerous brand and generic products for the best value, such as, price. Consumer simulator 102 is an application that executes on a computing device as described in detail in FIGS. 6-7. Consumer simulator 102 helps a retailer identify key success factors that determine a successful product and/or identify reasons for the product's failure. To identify key success factors, a retailer presents different scenarios to hundreds, or even thousands of consumers of the same or similar products. Example scenarios include different packaging, color, placement on a shelf, signage, etc.

In an embodiment, consumer simulator 102 presents consumers with multiple scenarios that include successful drivers of brand and/or generic products that have successful market share in a particular market. In an embodiment, these products are “brand” or generic products that are sold in numerous stores. In another embodiment, consumers may also be presented with private-label products. The private-label products may be products manufactured for a particular companies brand. In an embodiment, these products may be made to compete with the “brand” products. In a further embodiment, private-label products may be a low cost alternative to the “brand” products. In yet another embodiment, private-label products may also be “premium” products. In yet another embodiment, consumers may also be presented with consumer products that consumers buy for everyday use and require frequent replacement. Example consumer products may include cleaning products, such as a laundry detergent.

These successful drivers may be divided into multiple factors 104. Example and non-limiting factors 104 include awareness, findability, comparability and endorsement for a product.

For example, awareness is consumers' knowledge of the existence of a product. Findability may include an ability to disrupt consumers' walking down an isle in a store and finding a product on a shelf, and/or the ease of finding a product. Endorsement may include a belief of a consumer that a retailer supports the retailer's brand, is proud of the brand, and/or stands behind the brand. Comparability may include comparing a price of a product to the performance of the product, and also comparing the price and performance of the product to other similar products. Comparability may include an expensive product that performs well, an expensive product that performs poorly, a medium priced product that performs well, etc. In an embodiment, performance may also include performance of a product in light of disruptive and impactful messaging to a consumer regarding the product.

Each of factors 104 may be subdivided into multiple attributes 106. Attributes 106 are associated with different characteristics of a product, including look, marketing or product's location in the store. Example and non-limiting attributes 106 include packaging color, type of a label, and advertisement in a label, the location of a product on a shelf, signage associated with a product, etc.

In an embodiment, attributes 106 may be further subdivided into multiple categories 108. Categories 108 describe each attribute 106. For example attribute 106 that includes packaging color may have categories 108 that include orange, blue, white, green, yellow and purple colors, to name a few examples. In an embodiment, categories 108 are exclusive to a particular attribute 106 within factor 104.

In an embodiment, consumer simulator 102 displays different factors 104, attributes 106 and categories 108 for a product to consumers, and analyzes consumer feedback. For example, consumer simulator 102 allows a consumer to view products, such as different brand products, having different factors 104 and attributes 106, and allows a consumer to select a category from one or more categories 108 within each attribute 106. In another example, a consumer may be presented with a scenario that includes a compilation of attributes and pre-selected categories, and may select one of the presented scenarios. For example, a consumer may be presented with a first scenario where a product is in a blue packaging with a sign tag that includes a “100% guarantee” message, and a second scenario where a product is in an orange packaging, with a sign hanging over a shelf that includes a product, and with a “#1” claim message in the front of the product. A consumer may then select a product either from the first or second scenario. In yet another embodiment, a consumer may select a product that a consumer wishes to purchase. Once selected consumer simulator 102 identifies and selects factors 104, attributes 106 and categories 108 of the selected product. These selected categories are transmitted to consumer simulator 102 as consumer input 110. Consumer simulator 102 then stores and analyses consumer input 110 generated by multiple consumers. In one embodiment, consumer simulator 102 analyzes consumer input 110 using a discrete choice model. A person skilled in the art will appreciate that in a discrete choice model a decision maker, such as a consumer (but could also be an automated computer), makes a choice among a set of alternatives, such as selecting one category from categories 108 associated with a particular attribute 106.

In an embodiment, consumer simulator 102 generates output 112. Output 112 includes attributes 106, categories 108 and units 114. Units 114 are associated with each attribute 106 and category 108. In an embodiment, unit 114 may be a measure of effectiveness of attribute 106 compared to other attributes 106 and importance of attribute 106 to a consumer compared to other attributes 106. In another embodiment, unit 114 may also be a measure of effectiveness of a particular category 108 within attribute 106.

FIG. 2 is a block diagram 200 of a consumer simulator identifying successful drivers for an exemplary product, such as a detergent product, according to an embodiment. The type of product illustrated is exemplary only, and embodiments of the invention including consumer simulator 102 may be implemented for any suitable consumer product. Block diagram 200 includes findability 202 and comparability 204 factors as inputs for multiple detergent brands, for example. Findability 202 for a detergent may be a compilation of attributes, such as, for example, signage 206, bottle color 208, brand blocking 210 and share of shelf 212. The consumer simulator 102 may be adapted to include and manipulate other suitable attributes.

In an embodiment, signage 206 is associated with a type of a sign for a product (in this case a detergent). In an embodiment, signage 206 directs consumer's attention to the product. Signage 206 may have different categories, such as placing a sign above the shelf that holds the product (such as a sign hanging from a ceiling), placing the sign on a shelf that holds a product, or placing a sign onto a product, or shelf framing around the product. A person skilled in the art will appreciate that shelf framing is positioning a product on one or more shelves and then building a frame around the shelf or shelves so that the product calls attention to itself.

In an embodiment, color 208 may include packaging color that is associated with a successful product. For example, products that are packaged in orange, blue, purple, yellow, white and green may be associated with being successful products.

In an embodiment, brand blocking 210 may be associated with the way a product is placed on a shelf. For example, a product may be placed on a shelf in a clean brand block. A clean brand block is when a product is placed on a shelf continuously and without other products in between. In another example, a product may be placed in a broken brand block. In a broken brand block the products may be placed on different shelves, or vary in levels of the shelves in a store aisle. In another example, a product may be scattered on multiple shelves and placed next to other products.

In an embodiment, share of shelf 212 may be a percentage or a number of shelves in an aisle that can hold the product. For example, products that command a large share of shelf 212 may be easier to find, and vice versa. For example a product may occupy 3%, 6% and 10% of the available shelf space in the aisle.

Example attributes for comparability 204 factor may include a “compare to” message 214, label design 216, performance claim 218, and a signage message 220.

In an embodiment, “compare to” message 214 is a message on a product that instructs a consumer to compare a product to another similar brand or generic product that may belong to a competitor. In an embodiment, “compare to” message 214 indicates that the product is better than the “compared to” brand product.

In an embodiment, label design 216 constitutes a type of label design. One type of a label design is a design that it is similar to a popular of a well-known brand. Another type of a label design is a suggestive design. For example, for a laundry product, the label design may give a suggestion that the product may be used to clean laundry. Yet another type of a label design may be a realistic design.

In an embodiment, performance claim 218 may be a guarantee message. Example guarantee message may be “100% satisfaction guaranteed.” Such a message may give consumer confidence with respect to the performance of the product, such as a generic product. Another performance claim 218 may be a type of technology. For example, for a laundry product, performance claim 218 may be a “clean lift technology.” Another performance claim 218 may be a number one (“#1”) claim.

In an embodiment, a signage message 220 is a message that is placed on a sign displayed above or on a shelf, or on a product. Example signage message 220 is a complete value message. A complete value message may include one or more of a value message, a guarantee message, a technology message and/or a coupon.

A consumer using consumer simulator 102 may be presented with different combinations of findability 202 and comparability 204 factors, the corresponding attributes 206-220, and the categories associated with attributes 206-220. Example categories for attributes may include “yellow” for color 208 and “100% satisfaction guaranteed” message for performance claim 218. In an embodiment, the combinations of findability 202 and comparability 204 factors may correspond to drivers for successful products. Because the market share of successful brand or generic products is known or may be determined, consumer simulator 102 may use the market share along with the consumer input 110 to determine findability units 222 for findability 202 and comparability units 224 for comparability 204. In an embodiment, findability units 222 include relationships between attributes 206-212, as well as categories within attributes 206-212. In an embodiment, comparability units 224 include relationships between attributes 214-220, as well as categories within attributes 214-220. As discussed above, consumer simulator 102 may use a discrete choice model to determine findability units 222 and comparability units 224.

FIG. 3 is a block diagram 300 of a market share simulator, according to an embodiment. A retailer may use a market share simulator 302 to determine an expected market share that a product is likely to capture based on a set of categories that describe a product, advertising of the product and marketing for the product, as selected by the retailer and dictated by the store and financial top/bottom lines. For example, market share simulator 302 may determine an expected market share that a generic product, such as a generic detergent may have when compared to different brand products, such as brand detergents. 302 may be used to determine an expected market share for private-label products or consumer products, discussed above. In one embodiment, market share simulator 302 may be used in conjunction with data obtained by consumer simulator 102, such as, for example, output 112 to determine and display an expected market share to a user, such as, for example, a retailer that produces the generic product. As discussed above, output 112 may be generated using simulated data generated by consumers being presented with different scenarios and/or attributes of the competing products, and selecting a product that has particular attributes.

In an embodiment, a retailer may market a generic product such as a “private label” or “store brand” for a product, where the “store brand” is associated with a retailer's store and may be sold in the retailer's store or a subset of stores. In an embodiment, the “store brand” competes with “national brands,” also referred to as “brand products” that are sold in numerous stores that may or may not be associated with a retailer. To capture the market share of the product associated with “national brand” the retailer may use market share simulator 302 to identify and optimize the success drivers for the “store brand” before placing the “store brand” on the shelves to compete with the “national brands.”

In an embodiment, market share simulator 302 presents a retailer with a set of attributes 304a . . . 304n and categories 306 within each attribute. For example, attribute 304a includes categories 306a1 . . . 306aN, attribute 304b includes categories 306b1 . . . 306bN, etc. A retailer using market share simulator 302 may select a category from categories 306 associated with each attribute 304. For example, the retailer may select category 306a1 from attribute 304a, category 306b3 from attribute 306b and category 306n2 from attribute 304n. In an embodiment, the selected categories for the corresponding attributes 304 are referred to as a selected data set 308 that serves as input to market share simulator 302. The selected data set may include one or more categories 306. Based on the selected data set 308, market share simulator 302 generates an expected market share 310 of a product as an output.

Once a retailer selects data set 308, market share simulator 302 determines expected market share 310 based on the selected data set 308 and output 112 generated using consumer simulator 102. To determine the expected market share 310, market share simulator 302 applies a discrete choice model analysis that generates an expected market share 310 for a product.

In an embodiment, market share simulator 302 uses a prediction equation to generate expected market share MSᵢ(s):

$${MS}_{i} ( s ) = \frac{Exp [ {V}_{i} ( s ) ]}{\sum Exp [ {V}_{i} ( s ) ]}$$

MSᵢ(s) is a market share alternative “i” in a segment combination “s” where “s” is a segment type of users of a product. For example, a retailer may wish to determine a market share for consumers of a product that are heavy (or repeated) users of a product, low or occasional users, etc. For example, a retailer may attempt to determine expected market share 310 for the heavy users of a product when the product includes yellow packaging (attribute=“color”, category=“yellow”). A retailer may then attempt to determine expected market share 310 for occasional users of the product based on the same criteria.

Vᵢ(s) is utility of alternative segment combination “s”. In an embodiment, Vᵢ(s) may be a combination of data that includes an intercept, attribute effects, segment effects and segment less specific attribute effects.

For example, Vᵢ(s) may be utility associated with packaging in a particular color. To determine the impact of changing the packaging color of a product, from, for example, blue to yellow, market share simulator 302 may run two simulations. The first simulation may calculate the expected market share for a product having blue packaging. The second simulation may calculate the expected market share for a product having yellow packaging. Once calculated, market share simulator 102 may determine the impact of changing the color of packaging of a product from blue to yellow by calculating the difference in expected market shares from the first and second simulations.

As shown in the prediction equation above, the prediction equation also utilizes the summation of alternative segments combinations for the same type of product that is sold by different brands. These alternative segment combinations may be generated using output 112 derived using consumer simulator 102 discussed in FIGS. 1 and 2. For example, as discussed above, units 114 determine the relationship between the categories 108 in attribute 106, as well as the relationship between attributes 106 for the same and different brands.

Market simulator 302 then generates expected market share 310 (MSi(s)) by comparing the utility of an alternative segment as set by the retailer in data set 308 to the sum of the alternative segments generated by market simulator 302 based on output 112.

Once market share simulator 302 determines expected market share 310, a retailer using market share simulator 302 is able to change the selection of the one or more categories 306 in the one or more attributes 304a-n and determine how the change in selected one or more categories 306 affects expected market share 310 for a product. For example, as shown in block diagram 300, initially a retailer sets data set 308 to category 306a1 for attribute 304a, category 306b3 for attribute 306b and category 306n2 for attribute 304n. The retailer then wants to evaluate the effect on expected market share 310 by setting attribute 304a to category 306a3 (not shown), and recalculating expected market share 310. The change in expected market share 310 determines the effect of a product changing from category 306a1 to category 306a3 for attribute 304a.

In another embodiment, a retailer may be forced or wants to change categories 306 for attribute 304. For example, suppose a retailer may no longer be allowed or no longer chooses to use a hanging sign for a signage attribute. In this case, a retailer may use market share simulator 302 to determine the effect on a market share of a product if a retailer switches from a hanging sign to a sign on a product.

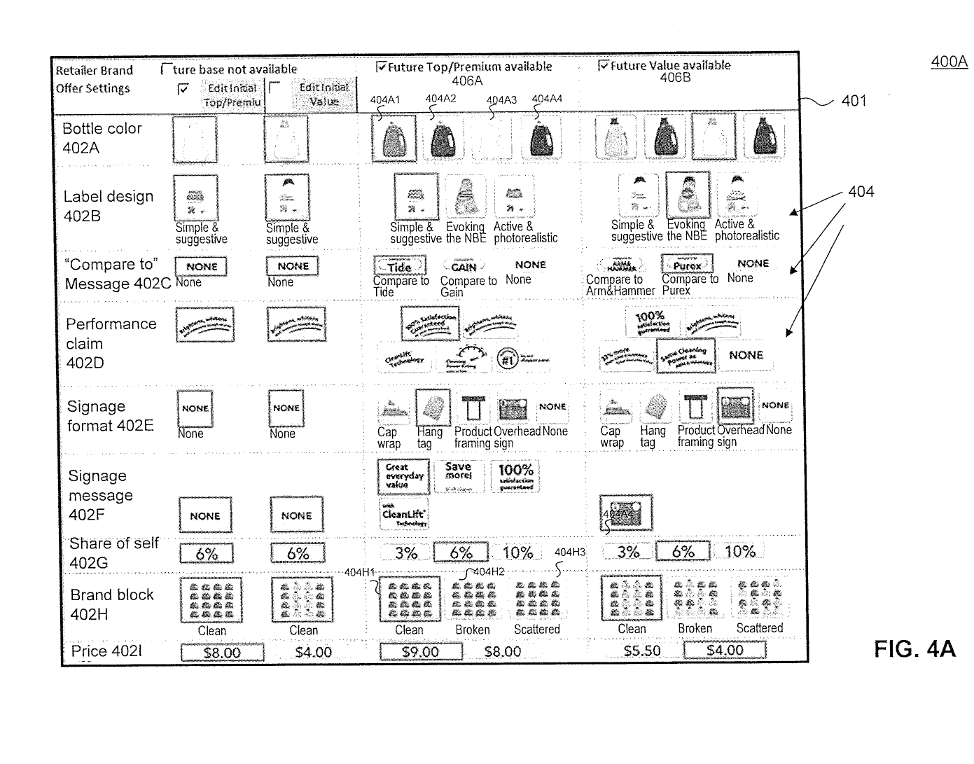

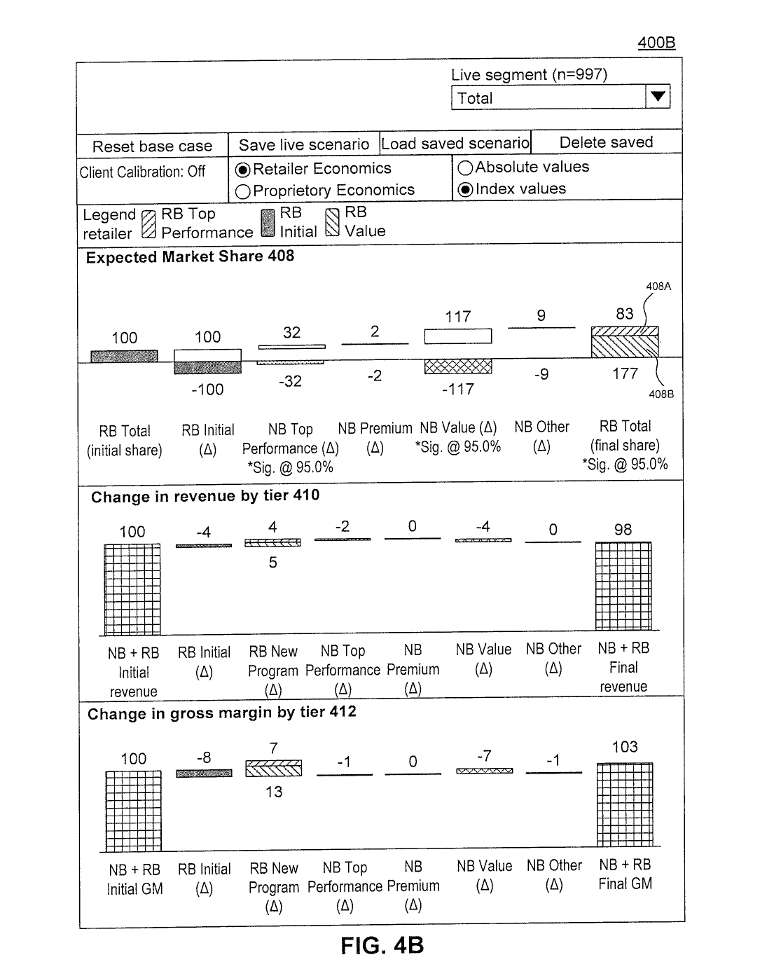

FIGS. 4A and 4B are diagrams 400A and 400B of a front-end of a market share simulator that evaluates an expected market share for a detergent, according to an embodiment. The type of the front-end of the market share simulator is exemplary, and the embodiment including the front-end of the market share simulator, and in for example, conjunction with the back-end of the market simulator may be implemented to determine a market share for a generic and/or brand product. In a further embodiment, the front-end of the market share simulator is a graphical user interface which displays selectable attributes, one or more of which are inputs to market share simulator 302, and also graphs and tables which provide a visual results of the increase or decrease in the market share as a result of the selected attributes.

In FIG. 4A, a retailer is presented with market share simulator front-end 401 that includes, for example, nine attributes 402A-I. These example attributes include “Bottle color,” “Label Design,” “Compare to” message, “Performance claim,” “Signage Format,” “Share of shelf,” “Brand block,” “Signage Message,” and “Price.” Market share simulator front-end 401 may be adapted to include and manipulate other suitable attributes.

In an embodiment, each of nine attributes 402A-I are further subdivided into categories 404, that may vary for each of the nine attributes 402A-I. For example, attribute 404A (“Bottle color”) is further subdivided into four color categories 404A1-404A4, that include “orange,” “blue,” “white,” and “purple.” In another example, category 404H (“Brand block”) is further subdivided into three block categories 404H1-3, including “clean,” “broken,” and “scattered.” A retailer using the market simulator front-end 401 is able to select a category 404 from each of attributes 402A-I.

In another embodiment, market share simulator front-end 401 also divides categories 404 into different tiers. For example, in FIG. 400A, market share simulator front-end 401 includes a premium tier 406 (market as “Future/Top Premium available”) and a value tier 408 (marked as “Future Value available”). Premium tier 406A and a value tier 406B provide a retailer with an option of analyzing products in different tiers. Premium tier 406A refers to premium products that may be more expensive or brand products, while value tier 406B refers value products that may be less expensive or generic products.

In an embodiment, premium tier 406A and value tier 406B may have different attribute characteristics 404 for attributes 402. For example, attribute 404A (“Bottle color”) includes “orange,” “blue,” “white,” and “purple” characteristics in premium tier 406A and “yellow,” “blue,” “white,” and “purple” characteristics in value tier 406B. The multiple tier option provides a retailer with yet another option for determining which tier(s) to place the product in, and how a tier will affect expected market share 310 of the product.

FIG. 4B is a block diagram of an expected market share for a detergent that is based on the categories set in FIG. 4A, according to an embodiment. As part of the market share analysis, market share simulator 302 generates the expected market share 408 for premium tier 406A (as 408A) and for value tier 406B (as 408B), as well as a change in revenue by tier 410, and a change in a gross margin for a product by tier 412. A person skilled in the art will appreciate that the diagram in FIG. 4B is an exemplary embodiment, and can also be used to compare a market share for a generic product as compared to brand products.

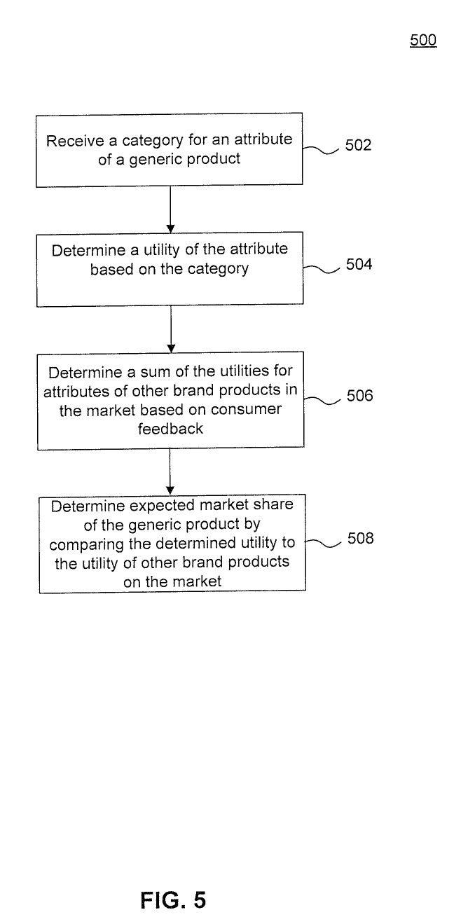

FIG. 5 is a flowchart of a method 500 for determining expected market share for a product, according to an embodiment.

At operation 502, selected categories for attributes are received. For example, a retailer selects one or more categories 306 from one or more attributes 304 and transmits the selected categories 306 for each attribute 304 to market share simulator 302 as data set 308. Once selected, market share simulator 302 receives data set 308 and determines expected market share 310 for a generic product. In one embodiment, a retailer may select “color” (attribute 304) that is “yellow” (category 306) for packaging of a product. The yellow color is then transmitted as part of data set 308 and is received by market share simulator 302. In a further example, the one or more categories 306 may be selected using a front-end interface shown in FIG. 4A.

At operation 504, a utility of each attribute is determined. For example, market share simulator 302 determines the utility of each attribute 304 based on the associated selected category 306. In an embodiment, market share simulator 302 uses a discrete choice model to calculate the utility. For example, market share simulator 302 determines utility of the color attribute when the color attribute is set to yellow. Market share simulator 302 may also determine utilities of other attributes 304 and categories 306 that describe the generic product but were not part of data set 108, as well as the effect of a yellow color on these other attributes 304. In the exemplary discrete choice model, operation 504 may include determining a value for Exp [Vi(s)].

At operation 506, a sum of utilities for each attribute is determined. For example, market share simulator 302 determines the utility of similar products, such as brand products produced by national brands, and calculates a summation of utilities for the similar products for each attribute. In an embodiment, to calculate the utility of the similar products, market share simulator 302 uses the data obtained by the consumer simulator 102, such as output 112. For example, market share simulator uses output 112 to determine utility of the color attribute and the corresponding color of other products, as well as other attributes. In the exemplary discrete choice model, operation 506 may include determining a value for Σ(Exp [Vᵢ(s)]).

At operation 508, expected market share is generated. For example, market share simulator 302 calculates expected market share 310 for a generic product by dividing the utility of the product determined in operation 504 by the sum of the utilities of the products determined in operation 506. In a further example, the expected market share may be displayed using a front-end interface shown in FIG. 4B. Once market share simulator 302 generates expected market share 310 for a product, a retailer may tweak some or all categories 306 for attributes 304 to extrapolate categories 306 that generate the best expected market share for a product. In the exemplary discrete choice model, operation 508 may include determining a value for Exp [Vᵢ(s)]/Σ(Exp [Vᵢ(s)]).

Consumer simulator 102 and market share simulator 302 may operate in a variety of computing environments. In one embodiment, consumer simulator 102 and market share simulator 302 may be downloaded onto a computing device. In another embodiment, consumer simulator 102 and market share simulator 302 may execute in a client server environment. Both of the environments are discussed in detail in FIG. 6, block diagram 600.

Block diagram 600 includes a client device 604 and a server device 606 that are connected by network 602. Client device 604 is an electronic device that is controlled and/or manipulated by a user. Client device 604 is capable of requesting and receiving resources, applications, data, etc., over network 602. Examples of client device 604 include personal computers, laptop computers, smartphones, and tablet computers, and any other electronic devices that can connect to network 602. Client device 604 may have some or all components of a computer system described in FIG. 7.

In one embodiment, consumer simulator 102 and market share simulator 302 may be downloaded onto client device 604, using network 602, a thumb drive, a compact disc, etc. Once downloaded, consumer simulator 102 and market share simulator 302 may be stored in one or more memories of the computing device and executed on one or more processors. Examples of one or more memories and one or more processors are discussed in detail in FIG. 7. Further, consumer simulator 102 and market share simulator 302 may also receive input using one or more input devices, such as a mouse, a keyboard, a touch-screen input device, etc., that are also discussed in detail in FIG. 7.

Server 606 is a computing device that communicates with multiple client devices 604. Server 606 may receive requests from client devices 604, process requests and provide responses to the requests that encapsulate data displayed on client devices 604. One component of server 606 may be a web server that issues responses to client device 604 that include HyperText Markup Language (“HTML”) pages, scripts, images, video, etc., to name only a few examples. In an embodiment, the responses to client device 604 also include content, such as words, phrases, images and sounds, that may include embedded information (such as meta-information in hyperlinks) and/or embedded instructions (such as JavaScript scripts). Another component of server 606 may be an application coupled to a database that generates data for transmission to client device 604.

In an embodiment, consumer simulator 102 and market simulator 302 may be divided into front-end and back-end components. For example, a front-end for consumer simulator 608 and a front-end from market share simulator 610 may execute on client device 604, while a back-end for consumer simulator 612 and a back-end for market share simulator 614 may execute on server 606 that is connected to client 604 via a network 602. A user may use the front-end of consumer simulator 608 and/or the front-end of market share simulator 610 to select attributes 106, 304, categories 108, 306, etc., and view output such as expected market share 310, while back-end for consumer simulator 612 and back-end for market share simulator 614 perform calculations based on the input, including attributes 106, 304 and categories 108, 306, and produce the output 112 and expected market share 310.

Network 602 may be any network or combination of networks that can carry data communication. Network 602 may include, but is not limited to, a local area network, metropolitan area network, and/or wide area network such as the Internet. Network X02 can support technologies including, but not limited to, the World Wide Web (“the Web”) that provide access to services and applications using protocols, such as a HyperText Transfer Protocol (“HTTP”). Intermediate web servers, gateways, or other servers may be provided between components of the system shown in FIG. 6, depending upon a particular application or environment.

Various embodiments in FIGS. 1-6 can be implemented, for example, using one or more computer systems, such as computer system 700 shown in FIG. 7. Computer system 700 can be any computer capable of performing the functions described herein, such as computers available from International Business Machines (“IBM”), Apple, Sun, Hewlett Packard (“HP”), Dell, Sony, Toshiba, etc.

Computer system 700 includes one or more processors, such as a processor 704. Processor 704 may include any conventional or special purpose processor, including, but not limited to, a digital signal processor (DSP), field programmable gate array (FPGA), or application specific integrated circuit (ASIC). Processor 704 is connected to a communication infrastructure or bus 706.

One or more processors 704 may also be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 700 also includes user input/output device(s) 702, such as monitors, keyboards, pointing devices, touch-screen devices, etc., which communicate with communication infrastructure 706 through user input/output interface(s) 703. Example communication infrastructure 706 may include one or more device interconnection buses such as Ethernet, Peripheral Component Interconnect (PCI), and the like.

Computer system 700 also includes a main or primary memory 708, such as random access memory (RAM). Main memory 708 may include one or more levels of cache. Main memory 708 has stored therein control logic (e.g., computer software) and/or data.

Computer system 700 may also include one or more secondary storage devices or memories 710. Secondary memory 710 may include, for example, a hard disk drive 712 and/or a removable storage device 714. Removable storage drive 714 may be a floppy disk drive, a magnetic tape drive, a compact disc drive, an optical storage device, tape backup device, USB port, removable memory chip socket, memory card slot, and/or any other storage device/drive.

Removable storage drive 714 may interact with a removable storage unit 718. Removable storage unit 718 includes a computer-readable storage device having stored thereon computer software (control logic) and/or data. The interaction allows computer programs and/or other instructions and/or data to be accessed by computer system 700. Removable storage unit 718 may be a floppy disk, magnetic tape, compact disc, DVD, optical storage disk, a removable memory chip (such as an EPROM or PROM), a memory stick, a memory card, and/any other computer data storage device. Removable storage drive 714 reads from and/or writes to removable storage unit 718 in a well-known manner.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of local area networks (LANs), wide area networks (WANs), the Internet, etc. Control logic and/or data may be transmitted to and from computer system 700 via communication path 726.

In an embodiment, a tangible apparatus or article of manufacture comprising a computer-readable medium having control logic (software) stored thereon is also referred to herein as a computer program product or program storage device. This includes, but is not limited to, computer system 700, main memory 708, secondary memory 710, and removable storage units 718, as well as tangible articles of manufacture embodying any combination of the foregoing. Such control logic, when executed by one or more data-processing devices (such as computer system 700), causes such data-processing devices to operate as described herein.

Based on the teachings contained in this disclosure, it will be apparent to persons skilled in the relevant art(s) how to make and use the invention using data-processing devices, computer systems and/or computer architectures other than that shown in FIG. 7. In particular, embodiments may operate with software, hardware, and/or operating system implementations other than those described herein.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

Embodiments may also be directed to computer program products comprising software stored on any computer-usable or computer-readable storage medium. Such software, when executed in one or more data-processing device, causes a data-processing device(s) to operate as described herein. Embodiments of the invention employ any computer-useable or computer-readable storage medium. Examples of computer-readable storage mediums include, but are not limited to, primary storage devices (e.g., any type of random access memory) and secondary storage devices (e.g., hard drives, floppy disks, CD-ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, and without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

What is claimed is:

1. A system, comprising:
one or more memories;
one or more processors coupled to the one or more memories; and
a market share simulator stored in the one or more memories and executing on the one or more processors and configured to:
receive a selected category for a selected attribute of a product;
determine a utility of the selected attribute based on the selected category;
determine a sum of a plurality of utilities for a plurality of attributes associated with a plurality of products, wherein the product and the plurality of products compete for a portion of a market share; and
compare the utility of the selected attribute to the sum of the plurality of utilities, wherein the comparison indicates an expected market share for the product.

2. The system of claim 1, wherein the market share simulator is further configured to:
display a first attribute and a second attribute for the product, wherein the first attribute is associated with a first plurality of categories and the second attribute is associated with a second plurality of categories exclusive from the first plurality of categories, and wherein the selected attribute is the first attribute and the selected category is included in the first plurality of categories or the second attribute and the selected category is included in the second plurality of categories.

3. The system of claim 1, wherein the market share simulator is further configured to:
display a first attribute associated with a first plurality of categories in a first tier and a second plurality of categories in a second tier, wherein the first tier and the second tier correspond to a price of the product.

4. The system of claim 1, wherein the market share simulator uses a discrete choice model that determines the utility of the selected attribute and the sum of the plurality of utilities.

5. The system of claim 1, wherein the market share simulator is further configured to:
receive a second selected category for the selected attribute of product; and
determine whether the second selected category results in an increase or a decrease in the expected market share of the product compared to the selected category.

6. The system of claim 1, wherein to determine the sum of the utilities, the market share simulator is further configured to utilize data generated using consumer simulations for the plurality of products.

7. The system of claim 6, wherein the consumer simulations for the plurality of products generate the plurality of utilities for an attribute associated with the plurality of products based on a discrete choice model.

8. The system of claim 1, wherein the market share simulator is further configured to display the expected market share for the product.

9. The system of claim 1, wherein the market share simulator is further configured to display the expected market share for the first tier and the second tier for the product.

10. A method, comprising:
receiving a selected category for a selected attribute of a product;
determining a utility of the selected attribute based on the selected category;
determining a sum of a plurality of utilities for a plurality of attributes associated with a plurality of products, wherein the product and the plurality of products compete for a portion of a market share; and
comparing the utility of the selected attribute to the sum of the plurality of utilities, wherein the comparison generates an expected market share for the product.

11. The method of claim 10, further comprising:
displaying a first attribute and a second attribute for the product, wherein the first attribute is associated with a first plurality of categories and the second attribute is associated with a second plurality of categories, exclusive from the first plurality of categories associated with the first attribute, and wherein the selected attribute is the first attribute and the selected category is included in the first plurality of categories or the second attribute and the selected category is included in the second plurality of categories.

12. The method of claim 10, further comprising:
displaying a first attribute associated with a first plurality of categories in a first tier and a second plurality of categories in a second tier, wherein the first tier and the second tier correspond to a price of the product.

13. The method of claim 10, further comprising:
using a discrete choice model to determine the utility of the selected attribute and the sum of the plurality of utilities.

14. The method of claim 10, further comprising:
receiving a second selected category for the selected attribute of product; and
determining whether the second selected category results in an increase or a decrease in the expected market share of the product compared to the selected category.

15. The method of claim 10, wherein determining the sum of the utilities, further comprises:
utilizing data generated using consumer simulations for the plurality of products.

16. The method of claim 15, whereby the consumer simulations for the plurality of products generate the plurality of utilities for an attribute associated with the plurality of products based on a discrete choice model.

17. The method of claim 10, further comprising:
displaying the expected market share for the product.

18. The method of claim 10, further comprising:
displaying the expected market share for the first tier and the second tier for the product.

19. A computer-readable storage medium having instructions stored thereon that, when executed by one or more processors, cause the one or more processors to perform operations, the operations comprising:
receiving a selected category for a selected attribute of a product;
determining a utility of the selected attribute based on the selected category;
determining a sum of a plurality of utilities for an attribute associated with a plurality of products, wherein the product and the plurality of products compete for a portion of a market share; and
comparing the utility to the sum of the plurality of utility, wherein the comparison generates an expected market share for the product.

20. The computer-readable storage medium of claim 19, wherein the instructions cause the one or more processors to perform operations, the operations comprising:
displaying a first attribute and a second attribute for the product, wherein the first attribute is associated with a first plurality of categories and the second attribute is associated with a second plurality of categories, exclusive from the first plurality of categories associated with the first attribute, and wherein the selected attribute is the first attribute and the selected category is included in the first plurality of categories or the second attribute and the selected category is included in the second plurality of categories.
